(19) United States
(12) Patent Application Publication
(10) Pub. No.: US 2018/0087218 A1
(43) Pub. Date: Mar. 29, 2018

(54) METHOD FOR COATING PAPER MILL CYLINDERS AND CYLINDERS THUS OBTAINED

(71) Applicant: A. CELLI PAPER S.P.A., Capannori (LU) (IT)

(72) Inventors: Salvatore SORRENTINO, Pinerolo (TO) (IT); Mauro CELLI, Lucca (IT); Giuseppe ANTONINI, Lido di Camaiore (LU) (IT)

(21) Appl. No.: 15/572,025

(22) PCT Filed: May 4, 2016
(86) PCT No.: PCT/EP2016/060047

§ 371 Date: Nov. 6, 2017

(30) Foreign Application Priority Data
May 8, 2015 (IT) FI2015A000131

(51) Int. Cl. D21F 5/18; C09D 163/00; B05D 3/00

(52) U.S. Cl. CPC D21F 5/181; C08K 3/346; B05D 3/007; C09D 163/00

(57) ABSTRACT

A layer of polymer resin, typically a thermoset reactive two-component resin, is applied onto a Yankee cylinder (3). The resin is cross-linked in order to form a continuous coating layer or film, containing a charge of micro- and/or nano-sized particles, in order to increase hardness and thermal conductivity of the resin.

### DESCRIPTION

### Technical Field

The present invention refers, in general, to the field of paper manufacturing machines, in particular for wet manufacturing, wherein a ply of cellulose fibers suspended in water is subsequently subjected to water removal treatments. In particular, methods are described herein to provide protective coatings for surfaces intended to come into contact with a cellulose paper ply, especially tissue paper, for example in components of machines and plants for removing water from the ply of cellulose fibers.

Some embodiments described herein refer to dryers, so-called Yankee cylinders, for drying plies of cellulose fibers. If not otherwise specified, “Yankee cylinder” refers in general to a heated cylinder, onto which a ply of cellulose fiber is driven to remove water therefrom.

### Background Art

Paper is usually manufactured by means of wet processes. A pulp of cellulose fibers, suspended in water together with, further components such as dyes, moisture-resistant resins or the like, if required, is distributed on a forming fabric by means of headboxes. The percentage of fibers in the suspension is initially very low, typically equal to, or lower than, 10% by weight. Then water is removed from the ply formed on the forming fabric, wherein the ply, if necessary, passes from one to the other of more continuous members comprising forming fabrics and/or felts. When the fiber content, in weight percentage, is enough to give the ply good mechanical consistency, the ply is transferred from a forming felt or fabric and driven around one or more dryers or Yankee cylinders. The interior of dryers or Yankee cylinders is heated by means of a heat-transfer fluid, typically steam, for instance. The heat transferred through the cylindrical shell of the Yankee cylinder or dryer, around which the cellulose ply temporarily adheres and moves, causes the evaporation of residual water. In some cases, the ply is removed from the dryer or Yankee cylinder by means of a detaching or scraping blade, called doctor blade.

In order to achieve the desired quality, the tissue paper manufacturers shall accurately manage the production parameters, such as paper mass, thickness and touch. These parameters may be modified by means of low humidity and stronger adhesion between cellulose ply and Yankee cylinder. Moreover, by using temporary wet strength agents, debonding agents and spray softeners, it is possible to achieve a greater wet-dry resistance ratio.

However, this approach may modify the coating of the Yankee cylinder, as some of the chemicals used may transfer to the surface of the Yankee cylinder, thus making the coating more fragile and irregular. In addition, the coating becomes poorly uniform, and this may increase noise.

These systems, aimed at improving the features of the coating of the paper that shall be dried on the surface of the Yankee cylinder, have not taken enough into account the role of the surface features of the Yankee cylinder, on which the paper ply to be dried is put. Moreover, the operating and economic advantages deriving from a modular development of the features of wear-resistance, thermal conductivity, adhesion and grinding of the surface of the Yankee cylinder have not been studied systematically.

### SUMMARY

According to the present disclosure a coating is provided for the metal surfaces of components of plants for wet manufacturing of paper, especially tissue paper. More in particular, in some embodiments described herein Yankee cylinders, or dryers, are provided with a coating on the cylindrical outer surface of the Yankee cylinder, allowing to achieve high wear-resistance, good adhesion of the cellulose ply to the Yankee cylinder, effective heat exchange between the inside of the Yankee cylinder and the cellulose ply adhering to the cylindrical outer surface thereof.

According to a first aspect, a method for coating a cylinder for a drying unit for cellulose plies is provided, comprising the steps of forming a preferably continuous coating film, herein also simply called “coating” or “continuous coating film”, formed by a polymer resin, typically a thermoset resin, on at least one portion of the cylindrical outer surface of the cylinder.

The coating film is stable, stays adhering to the cylindrical surface of the cylinder, and forms the contact and adhesion surface between the cellulose ply and the cylinder. The detaching or scraping blade(s), or doctor blades, co-acting with the cylinder, are into contact with the outer surface of the coating film and slides thereon. In some embodiments, also the detaching or scraping blades or doctor blades may be provided with a coating film; in this case, the contact between cylinder and blade is a contact between two coating films having, if necessary, different hardness.

According to some embodiments described herein, a system is provided comprising a Yankee cylinder and at least one detaching and/or scraping blade and/or doctor blade combined thereto. In this case, a continuous coating film may be formed on the Yankee cylinder, the film hardness being equal to, and preferably greater than, that of a continuous coating film formed on the detaching or scraping blade or doctor blade. In this way, the wear of the coating is concentrated on the blade, that is the more economical, and easier to be replaced, element of the system.

In practical embodiments, the method comprises the steps of:
a) applying, to the outer surface of the cylinder to be coated, a coating based on a reactive two-component resin, comprising a cross-linkable resin and a hardener;
b) cross-linking the resin and forming the continuous coating film on the cylinder outer surface.

Cross-linking, polymerization or curing usually occurs through supply of energy, for example and preferably thermal energy, that may be supplied by means of a heat-transfer fluid flowing in the cylinder.

The film or coating may have, for example, a thickness equal to, or greater than, about 0.5 mm, preferably equal to, or greater than, about 1 mm, more preferably equal to, or greater than, about 1.5 mm, for example equal to, or greater than, about 2 mm, typically comprised between about 0.5 and 5 mm, preferably between about 2 and 4 mm. The coating film may be then ground, in order to give the outer surface of the Yankee cylinder a suitable shape. After grinding, the thickness of the final coating may be equal to, or lower than, about 2 mm, preferably equal to, or lower than, about 1.5 mm, for example equal to, or lower than, about 1 mm. In some embodiments, the thickness is comprised between about 0.5 mm and 0.8 mm.

The reactive two-component resin may comprise a resin constituted by oligomers (pre-polymers) and a hardener.

In some embodiments, the resin may be an epoxy resin, a polyurea resin or a polyurethane resin.

In order to increase the mechanical strength, and/or suitably modify or modulate other physical features of the coating film, for example thermal conductivity, the resin may be charged with particles, preferably nano-sized particles, micro-sized particles, or both nano-sized and micro-sized particles in combination, made of suitable materials.

According to some embodiments, the nano- or micro-sized particles are selected from the group comprising: nanosilicates, carbon nano tubes, graphene, graphene oxide, graphite, metal oxides such as, for example, aluminum oxide (Al₂O₃), silica (SiO₂), aluminum trihydroxide, montmorillonite, sodium montmorillonite, organic modified montmorillonite, copper powder or other metal powders, boron nitride, used individually or mixed together, or combinations thereof.

Some of the above listed substances, such as, in particular, metal powders, graphene, carbon nano tubes, graphene oxide, boron nitride, aluminum oxide, aluminum trihydroxide, may be used to increase both mechanical strength and thermal conductivity of the coating film. High thermal conductivity is a particularly useful feature for coating the cylindrical surface of dryers or Yankee cylinders, as it allows a better heat exchange between cylinder and cellulose ply and, thus, better efficiency in removing moisture from the cellulose ply.

The features of mechanical strength and conductivity of the coating film may be suitably changed and selected, for example by varying type, weight percentage and size of the charges added to the polymer resin. Typically, nano-sized particles, especially carbon nano tubes, graphene nanoparticles and metal nanoparticles, are particularly suitable to increase thermal conductivity of the coating film. Micro-sized particles are particularly suitable to increase mechanical strength of the coating film. Moreover, thermal conductivity increases as the charge percentage in the resin increases.

The resin and the micro- and/or nano-sized particles may be advantageously selected so that the film thermal conductivity is equal to, or greater than, about 1 W/m° K, preferably equal to, or greater than, about 2 W/m° K, more preferably equal to, or greater than, about 5 W/m° K, even more preferably equal to, or greater than, about 10 W/m° K.

For example, oligomeric resins (epoxy resins or other resins) may be used, containing a weight percentage of nano- and/or micro-sized charges comprised between 1 and 80% with respect to the weight of the base resin, excl. hardener and any other solvents or additives.

For example, the charges may be as follows: between about 1% and 15% by weight of nano-sized charges in combination with from about 1% to about 30% by weight of micro-sized charges.

More in general, according to embodiments of the method described herein, the oligomeric resin, before adding the hardener or cross-linking agent, may contain micro-sized and nano-sized particles, wherein the weight ratio between micro-sized and nano-sized charges is comprised between 5 and 10.

In some embodiments, even higher percentages than those indicated above with respect to the resin (excl. hardener and any solvent or diluent) may be used to achieve particularly high thermal conductivity. In general, the weight percentage of nano- and/or micro-sized particles may be comprised between about 1% and 90% with respect to the curable resin, i.e. to the resin excl. the weight of the hardener. The above mentioned percentage may be preferably comprised between about 1% and about 85%, more preferably between about 10% and about 80%, more preferably between about 20% and about 80%, more preferably between about 30% and about 80%, i.e. between about 40% and about 80% by weight with respect to the resin excl. solvents and hardener.

In some embodiments, phyllosilicates may be used, for instance montmorillonite, in form of lamellar particles of thickness comprised between about 1 nm and about 10 nm.

In some embodiments, the particle surface may be comprised between about 1,000 nm² and about 100,000 nm², preferably between about 5,000 and about 20,000 nm², for example between about 8,000 and about 12,000 nm². In some embodiments, the surface of the particles may be equal to, or smaller than, 10,000 nm².

In some embodiments, the particles may comprise multi wall carbon nano tubes (MWCT), the diameter whereof is comprised between about 5 nm and about 120 nm, preferably between about 10 nm and about 60 nm. The length-diameter ratio (so-called aspect ratio) of the nano tube may be comprised between about 10 and about 10,000, preferably between about 100 and about 5,000, more preferably between about 500 and 1,500.

In some embodiments, the particles may comprise graphene nanoparticles, the dimension whereof is comprised, for example, between about 2 nm and about 120 nm, preferably between about 5 nm and about 30 nm, and/or nano-platelets of thickness comprised between about 2 nm and about 20 nm, preferably between about 5 nm and about 10 nm, and surface comprised between about 10 nm² and about 10,000 nm², preferably between about 50 nm² and about 5,000 nm², for example between about 100 nm² and about 1,000 nm².

According to typical applications of the described method, the Rockwell hardness of the coating film may be equal to, or greater than, 58 HRC and preferably equal to, or greater than, about 61 HRC. For example, in some embodiments the Rockwell hardness of the coating film may be equal to, or greater than, about 64 HRC. In some embodiments, the Shore hardness of the coating film may be equal to, or greater than, about 80 Shore D, preferably equal to, or greater than, about 85 Shore D, for example equal to, or greater than, about 87 Shore D.

According to a further aspect, a method is also provided to repair a component of a system for drying a cellulose ply, for example a Yankee cylinder. The method comprises the step of replacing a layer of polymer resin, typically a thermoset polymer resin, for example a reactive two-component resin, on at least one portion of the cylindrical outer surface of the cylinder.

For example, a layer of a two-component resin is applied to the surface to be treated, the layer containing a curable resin and a hardener, with a micro- and/or nano-sized charge; then, in order to form a continuous coating, or coating film, the resin is cross-linked by supplying thermal energy, typically using a heat-transferring fluid flowing in the cylinder. If necessary, the method may comprise a preliminary step of removing an already existing coating film; then a new film is applied according to the steps described above. Alternatively, according to the method the resin coating film may be applied to a surface where there is already a coating film that may be partially damaged or incomplete.

According to a further aspect, a Yankee cylinder or the like is described, having a cylindrical outer surface coated with a continuous coating film made of hardened polymer resin.

In some embodiments, also a blade is provided a co-acting with a dryer or Yankee cylinder, for example a detaching blade to remove the cellulose ply from the cylindrical surface of a Yankee cylinder, a scraping blade and/or a doctor blade for the cylinder surface. In this case, at least one edge of the blade, configured and arranged so as to be into contact with the cylindrical surface of the Yankee cylinder, may be coated with a coating film of the type described above, if necessary with charges suitable to increase the hardness, but not necessary the thermal conductivity thereof, as this feature is not significant for scraping blades, or doctor blades.

Namely, in this case, the hardness of the blade coating film is preferably lower than the hardness of the film coating the surface of the Yankee cylinder.

The coating film of the cylinder contains a charge of micro- and/or nano-sized particles. The nano- and/or micro-sized particles are selected from the group comprising: nanosilicates, metal oxides, carbon nano tubes, graphene, graphene oxide, graphite, aluminum oxide, aluminum trihydroxide, silica, montmorillonite, organic modified montmorillonite, sodium montmorillonite, boron nitride, metal powders used individually or mixed together, such as copper powder, or combinations thereof.

The weight percentage of the nano- and/or micro-sized charges may be comprised between about 1% and about 30% with respect to the total weight of the film. For example, the weight percentage of nano-sized charges may be comprised between about 1% and about 30%, and the weight percentage of micro-sized charges may be comprised between about 5% and about 30% with respect to the total weight of the coating film. In other embodiments, especially in order to achieve particularly high thermal conductivity, the weight percentage of micro- and/or nano-sized charges with respect to the total weight of the film after cross-linking or curing may be comprised between about 10% and about 80%, preferably between about 15% and about 70%.

The glass transition temperature of the continuous coating film may be comprised between about 140° C. and about 180° C.

The thickness of the continuous coating film may be equal to at least 1 mm and preferably equal to at least 2 mm. In other embodiments, the thickness of the coating film may be equal to, or lower than, about 2 mm, preferably equal to, or lower than, about 1.5 mm, for example equal to, or lower than, 1 mm. In some embodiments, the thickness is comprised between about 0.4 mm and about 0.8 mm.

### BRIEF DESCRIPTION OF THE DRAWINGS

The present invention will be better understood by means of the description below and the attached drawing, which shows a non-restrictive practical embodiment of the invention. More particularly, in the drawing:

FIG. 1 shows a portion of a plant for manufacturing a cellulose ply, comprising a Yankee cylinder;

FIG. 2 schematically shows a plant for applying a film to the cylindrical outer surface of a Yankee cylinder;

FIG. 3 is a block diagram of the method according to the invention;

FIGS. 4-6 schematically show different modes for applying the charged resin to the surface of the Yankee cylinder.

### DETAILED DESCRIPTION OF EMBODIMENTS

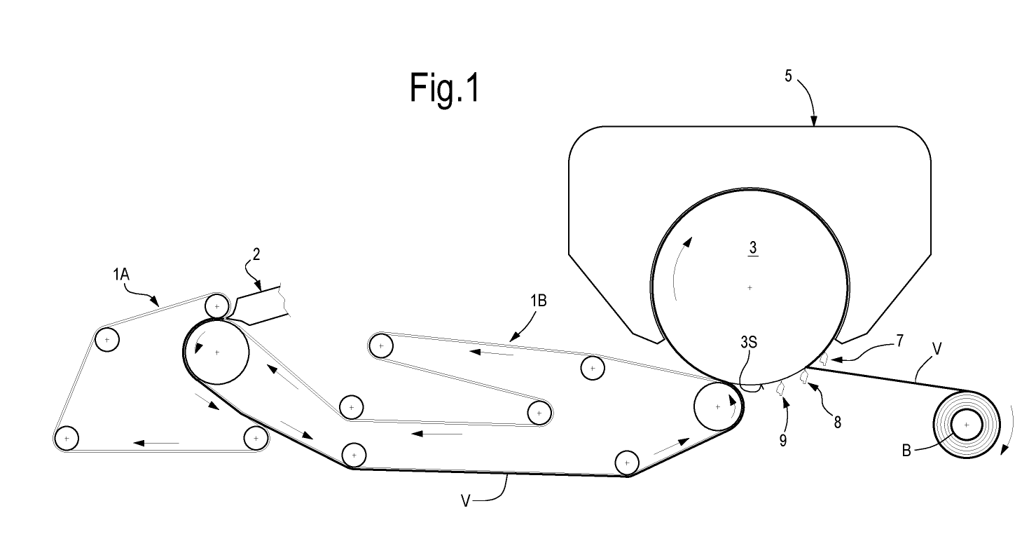

FIG. 1 shows a portion of a plant for manufacturing a ply of paper, for example tissue paper. In the figure, a headbox 2 is shown, supplying a suspension of cellulose fibers in water between a first continuous member 1A, for example a forming fabric, and a second continuous member 1B, for instance a forming felt. The continuous member 1B more downstream transfers the paper ply V to the outer surface 3S of a Yankee cylinder 3. The cellulose ply V adheres to the surface 3S of the Yankee cylinder, which is heated from the inside by means of pressurized steam or other suitable heat-transferring fluid. Air hoods 5 may be arranged around the Yankee cylinder 3, which inflate heated dry air and suck wet air from the area around the surface of the Yankee cylinder 3, in order to remove humidity from the cellulose ply V.

The ply V is then removed from the Yankee cylinder by means of a detaching, scraping or doctor blade 8, and is transferred to other members of the manufacturing line, known to those skilled in the art and therefore not described in detail. B schematically indicates a reel, around which the dry cellulose ply V is collected. Further scraping blades 7, 9 for scraping the surface 3S of the Yankee cylinder 3 may be arranged downstream of the detaching blade 8. In particular, the blade 7 operates in case the ply V breaks.

The cylindrical surface 3S of the Yankee cylinder 3 and/or the detaching blade 8 may be coated with a continuous coating film made of thermoset polymer resin, as described below.

As mentioned, the coating film for the Yankee cylinder 3, the detaching blade 8 or other components of the plant that come into contact with the cellulose ply V, may be made of a thermoset polymer resin, obtained in particular from a reactive two-component base resin, preferably containing a nano- or micro-sized charge, i.e. a charge constituted by nanometric or micrometric particles, or by a combination of nanometric and micrometric particles.

The resins usable for forming the coating film may be of various type. They may be chosen based upon various considerations. In particular, it is advantageous to use resins that do not release pollutants into the environment, i.e. that do not release gaseous organic emissions, especially during the cross-linking process. The components of the reactive two-component resin may be selected based on the molecular ratios between reactive groups and on the molecular structure thereof.

The micro- or nano-sized charge may be chosen according to the desired hardness and/or thermal conductivity, and may be constituted by one or more different substances.

The resins may be also chosen based on the adhesion of the coating film on the metal surface to be coated.

Below some embodiments of coating films will be described in detail, obtained from epoxy, polyurethane and polyurea resins, charged or not charged with nano-particles and/or micro-particles suitable to vary the hardness thereof and, thus, the wear-resistance and/or the thermal conductivity.

In the various embodiments illustrated herein, in each class of resins—epoxy, polyurethane, polyurea resins—the parameters of each component and the stoichiometric ratios have been changed, in order to modulate the features of the polymer matrix according to the film application.

Epoxy resins are widely used for the production of paints and adhesives with optimal adhesion and chemical and mechanical strength. In order to use epoxy resins, a thermal treatment (curing or cross-linking process) shall be performed that, by means of a hardening (or cross-linking) agent, promotes cross-linking reactions, thus obtaining polymer materials that are infusible and fragile and have good mechanical properties. These thermoset materials have a combination of properties, such as excellent chemical and mechanical strength, wear-resistance, good thermal properties, good electric properties and high dimensional stability. By acting on the formulation of the reaction mixture, i.e. by modifying the content of base epoxy resin, hardening agents and any charge and modifier, it is possible to suitably vary and balance these properties, in order to obtain a material specific to the intended use.

The reaction mixture, i.e. the reactive two-component resin, for the preparation of cross-linked epoxy resins, may be composed by epoxy resins with low molecular weight (oligomers), a hardener and any rheological modifier such as, for example, diluents, charges, tougheners, etc.

The base epoxy resins are oligomers of different molecular weight, containing epoxy reactive groups, usually arranged on the chain terminals. The number of epoxy groups in each chain determines the functionality of the resin, whereon the reactivity during curing or cross-linking depends. Bifunctional, trifunctional and tetrafunctional resins are available on the market. Multifunctional resins, i.e. resins with more than two epoxy groups per chain, achieve high performances thanks to the high density of cross-linking points. The most important parameters to be evaluated, through tests described in ASTM standards, are the following: Epoxy Equivalent Weight (EEW), glass-transition temperature (Tg), viscosity (a), molecular weight (Mw, mass-average molecular weight) and distribution thereof, molecular structure after cross-linking or curing.

The Epoxy Equivalent Weight (EEW) is the weight of resin necessary to obtain an equivalent of epoxy groups, that is an indirect index of the content of relevant groups and, therefore, of the stoichiometric content of the relevant groups in the resins subject to curing. It is defined by the formula

EEW=Mw/f

where:

Mw is the resin molecular weight; and

f is the number of functional groups per macromolecule.

The glass-transition temperature (Tg) is the temperature, below which a polymer is in glassy state, and above which it has a viscoelastic behavior.

If T>Tg, the elastic module, as well as other properties, such as viscosity and heat capacity, decrease by various orders of magnitude, while permeability and thermal expansion coefficient increase. Knowing Tg is therefore important to identify the right temperature of use of the polymer material. Viscosity is an important feature in the manufacturing processes. Namely, high viscosity prevents a good mixing with the hardening agent and, therefore, the formation of a non-homogeneous polymer material, while too low viscosity does not facilitate the processing. The molecular weight and the molecular structure significantly affect many features of the material, among which viscosity and Tg. As regards the chemical structure, different classes of unhardened resins may be identified, with diversified properties.

The first marketed epoxy resin is the resin based on Diglycidyl Ether of Bisphenol A (DGEBA), that is still today widely used. It is a bifunctional resin, with two terminal epoxy groups and repetitive units containing secondary hydroxyl groups. This resin is obtained from the condensation reaction between bisphenol A and epychloridrin, catalyzed by means of a base.

DGEBA resins are in the form of mixture in liquid or solid state, according to the molecular weight Mw. The features of these epoxy resins are linked to different factors. First of all, to the bisphenol A, that ensures hardness and strength even at high temperatures, thanks to the presence of aromatic rings in the structure thereof. Ether bonds ensure good chemical strength, while epoxy and hydroxyl groups ensure good adhesive properties. Liquid DGEBA resins are particularly viscous, with low Mw and number of repetitive units n=2 (n=polymerization degree).

They are usually used for the production of solid epoxy resins with high molecular weight, or cured, i.e. cross-linked, with various cross-linking agents (anhydrides, aliphatic amines, phenols, polyamides). They are effectively used for the formulation of thermosetting materials destined to coatings, composites, floors, and in processes where their low viscosity facilitates the manufacturing processes. DGEBA solid resins have high molecular weight, a number n of respective units comprised between 2 and 35. They distinguish from one another by Mw, EEW and viscosity, according to the polymerization degree. Also these resins are subjected to thermal treatments (cross-linking) in order to form a cross-linked solid. The longer the chain is, and therefore the higher the value n is, the greater the flexibility of the cross-linked resin is, as the final epoxy groups, from which the branches start, are more distant from one another and therefore reduce the cross-linking density per volume unit.

As epoxy resin for the production of coating film for components of plants for wet manufacturing of paper, it is possible to use, in particular, a DGEBA epoxy resin marketed by Dow Chemicals, USA, under the name D.E.R.332. This is a liquid epoxy resin with epoxy equivalent weight equal to 176 g/eq (epoxy equivalent weight of pure diglycidyl ether of bisphenol A is 170 g/eq). This epoxy resin ensures uniform performances and very low viscosity, small amount of chlorides and light color. This resin may be cross-linked by means of many hardening agents, such as polyamides.

Other usable resins are indicated below, with reference to some embodiments. All the used resins are interchangeable and may be used alternatively, also depending upon the type of added charges and upon the percentage thereof. For the experiments, commercial resins have been used, that have been already tested and are provided with environmental technical specifications and end use certificates.

The tests have been carried out by charging the liquid epoxy resin of formula (I) with the charge of micro- and nano-sized particles; then, the mixture has been reacted with amine hardeners of formula (II), also varying the weight ratio, and therefore the ratio between complementary functional groups.

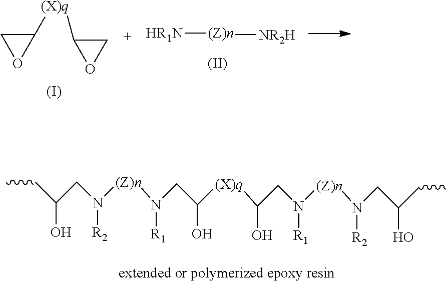

wherein:
R₁, R₂ can be independently: H, alkyl group, aromatic group, alkyl or aromatic ester group, siloxane group, ether aromatic group typically furan, under the condition that R₁ and R₂ are not both H.
X is a linear alkyl group or a branched alkyl group, a cycloaliphatic group, or an aromatic group;
Z is a linear alkyl group or a branched alkyl group, an aromatic group, an amine functional group
q=2-20
n=2-20
where q and n may be independently equal to each other or different from each other.

Some exemplary embodiments of polymer films based on cross-linked epoxy resins, charged and uncharged, have been obtained starting from a commercial liquid epoxy resin (EPOSIR 7120, marketed by SIR Industriale S.p.A., Italy), with structure:

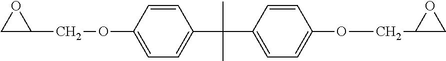 [SMILES: CC(C)(c1ccc(OCC2CO2)cc1)c1ccc(OCC2CO2)cc1]

and using diethylenetriamine (DETA=H₂N—CH₂CH₂—NH—CH₂—CH₂—NH₂) as hardening agent. The ratio between liquid epoxy resin and hardener has been optimized according to the hardness of the uncharged resin. The samples described below have a ratio between liquid epoxy resin equivalents and hardener equal to 3.5. Using this ratio, an uncharged cross-linked resin with greater hardness has been obtained.

Then, different specimens have been prepared dispersing different nanometric charges, in particular:
multi-wall carbon nano tubes (MWCNT). In particular, the product Baytubes C150P has been used, marketed by BAYER MATERIALSCIENCE AG, Germany, having a diameter of 10-60 nm and length-diameter ratio up to 1,000,
phyllosilicate (sodium montmorillonite, indicated below with MMT). In particular, the product DELLITE 72T, has been used, marketed by Laviosa Chimica Mineraria S.p.A., Italy, in form of lamellar particles, having a thickness of 1-10 nm and a surface up to 10,000 nm².

All specimens have been prepared by dispersing the nano-charge in the uncharged epoxy resin (after having added 1 ml acetone to decrease the system viscosity), sonicating the mixture for about 30 minutes and then adding the hardener. After mixing and charge dispersion, the specimens have been cross-linked. Table 1 show the specimens prepared with the corresponding charge and the parameters of the cross-linking process adopted (time expressed in h and temperatures in ° C.). For each specimen, the Rockwell hardness HRC is shown.

TABLE 1

| | weight % | Rockwell | |
|---|---|---|---|
| | and type of | hardness | |
| specimen | charge | HRC | Cross-linking conditions |
| R1 | — | 58-60 | 2 h at room temperature |
| | | | 2 h 50° C. |
| | | | 2 h 70° C. |
| R1-A | 1.5% | 62.1 | 2 h at room temperature |
| | MMT | | 2 h at 50° C. |
| | | | 2 h at 70° C. |
| R1-B | 3% | 62.1 | 2 h room temperature |
| | MMT | | 2 h at 50° C. |
| | | | 2 h at 70° C. |
| R1-C | 1.5% | 60.3 | 2 h at room temperature |
| | MWCNT | | 2 h at 50° C. |
| | | | 2 h at 70° C. |

These resins can be used, for example, for coating the surface of the scraping blades or detaching blades or doctor blades. Below, the procedures used for preparing the specimens indicated in Table 1, charged with nano- or micro-sized particles, are detailed.

### EXAMPLE 1

Nanocomposite R1-A: 0.045 g (1.5% by weight with respect to the not cross-linked epoxy resin) sodium montmorillonite (marketed by Laviosa Chimica Mineraria S.p.A., Italy) have been added to 3 g epoxy resin EPOSIR 7120 (marketed by SIR Industriale S.p.A., Italy) with 1 ml solvent (acetone). Then, 0.531 g hardener (diethylenetriamine) have been added to the previously charged epoxy resin. The specimen has been kept for 2 hours at room temperature, then for 2 hours at 50° C., and then for 2 hours at 70° C. The Rockwell hardness of the specimen after cross-linking was equal to 62.1 HRC.

### EXAMPLE 2

Specimen R1-B: 0.09 g (3% by weight with respect to the not cross-linked epoxy resin) sodium montmorillonite (MMT, Laviosa) have been added to 3 g epoxy resin EPOSIR 7120 with 1 ml solvent. Then, 0.531 g hardener (diethylenetriamine) have been added to the previously charged epoxy resin. The specimen has been kept for 2 hours at room temperature, then for 2 hours at 50° C., and then for 2 hours at 70° C. After cross-linking, the Rockwell hardness of the specimen was 62.1 HRC; the specimen has been deposited on a doctor blade for a thickness of 1 mm.

### EXAMPLE 3

Nanocomposite R1-C: 0.045 g (1.5% by weight with respect to the epoxy resin) multi-wall carbon nano tubes (MWCNT) Baytubes C150P, marketed by BAYER MATERIALSCIENCE AG, Germany, have been added to 3 g epoxy resin EPOSIR 7120 with 1 ml solvent. Then, 0.531 g hardener (diethylenetriamine) have been added to the previously charged epoxy resin. The specimen has been kept for 2 hours at room temperature, then for 2 hours at 50° C., and then for 2 hours at 70° C. After cross-linking, the Rockwell hardness of the specimen was 60.3 HRC.

In addition to the three examples indicated in the table, the following specimens have been also prepared:

### EXAMPLE 4

Nanocomposite R1-A-BIS: 0.18 g (3% by weight with respect to the not cross-linked epoxy resin) sodium montmorillonite (MMT, Laviosa) have been added to 6 g epoxy resin EPOSIR 7120 with 1 ml solvent. Then, 0.97 g hardener (diethylenetriamine) have been added to the previously charged epoxy resin. The specimen has been kept for 2 hours at 50° C., then for 2 hours at 70° C. After cross-linking, the Rockwell hardness of the specimen was 62.1 HRC.

### EXAMPLE 5

Nanocomposite R1-C-BIS: 0.09 g (1.5% by weight with respect to the epoxy resin) nanotubes (Baytubes C150P, BAYER MATERIALSCIENCE AG, Germany) have been added to 6 g epoxy resin EPOSIR7120 with 1 ml solvent. Then, 0.97 g hardener (diethylenetriamine) have been added to the previously charged epoxy resin. The specimen has been kept for 2 hours at 50° C., then for 2 hours at 70° C. After cross-linking, the Rockwell hardness of the specimen was 60.3 HRC.

The films obtained according to the examples 1-5 are particularly suitable to coat detaching blades or scraping blades or doctor blades that can be used with a Yankee cylinder. The Yankee cylinder coating film may be produced with a harder resin, so as to avoid the wear thereof, concentrating on the blade the wear due to blade-cylinder friction.

In order to increase the hardness of the resin, tests have been also made using other resins and other hardeners, in particular a more rigid aromatic hardener and nanometric charges based on graphene and graphene oxide.

The epoxy resin EP-506 has been used, marketed by CHEMIX s.r.l., Varese, Italy, in combination with a hardener (3.3-dimethyl-4.4-diamine-dicyclohexylmethane). The epoxy resin-hardener ratio used as optimal was 100/32 by weight.

Resin specimens have been prepared by dispersing nanometric charges (0.1%-15% by weight) of the following products:
multi wall carbon nano tubes (MWCNT) Baytubes C150P, marketed by BAYER MATERIALSCIENCE AG, Germany
phyllosilicate (sodium montmorillonite=MMT marketed by Laviosa Chimica Mineraria S.p.A., Italy)
graphene nanoparticles (GF),
graphene oxide microparticles (GFO) (3% by weight)
poorly acid aluminum oxide (Al₂O₃) (150 mesh)
silica (SiO₂ 70-230 mesh)
graphite microparticles

All specimens have been prepared by dispersing the nano- or micro-sized charge in the not cross-linked resin (without solvent) and sonicating the mixture for 1 hour, then adding the hardener. After mixing and charge dispersion, the specimens have been cross-linked. Table 2 shows the data for the specimens with the corresponding charge and type of cross-linking used. Table 2 also shows the hardness of each specimen. For each specimen, the Rockwell hardness in HRC is indicated.

TABLE 2

| | weight % | | | |
|---|---|---|---|---|
| | type of | | | |
| | charge with | weight % | | |
| | respect to the | and type of charge | Rockwell | |
| speci- | starting epoxy | on the total (resin | hardness | |
| men | oligomer | after cross-linking) | HRC | cross-linking |
| R2 | — | | 64 | 4 h at 80° C. |
| R2-A | 1.5% MMT | 1.14% MMT | 64.4 | 4 h at 80° C. |
| R2-B | 3% MMT | 2.27% MMT | 64 | 4 h at 80° C. |
| R2-C | 1.5% MWCNT | 1.14% MWCNT | 64 | 4 h at 80° C. |
| | | | | 3 h at 120° C. |
| R2-D | 3% MWCNT | 2.27% MWCNT | 64.4 | 4 h at 80° C. |
| | | | | 3 h at 120° C. |
| R2-E | 5% SiO₂ | 3.79% SiO₂ | 63.1 | 4 h at 80° C. |
| R2-F | 10% SiO₂ | 7.58% SiO₂ | 64 | 4 h at 80° C. |
| R2-G | 5% Al₂O₃ | 3.79% Al₂O₃ | 64 | 4 h at 80° C. |
| R2-H | 10% Al₂O₃ | 7.58% Al₂O₃ | 64 | 4 h at 80° C. |
| R2-I | 5% SiO₂ | 3.79% SiO₂ 1.14% | 64 | 4 h at 80° C. |
| | 1.5% MWCNT | MWCNT | | |
| R2-L | 5% SiO₂ | 3.79% SiO₂ 1.14% | 64 | 4 h at 80° C. |
| | 1.5% MWCNT | MWCNT | | |
| R2-J | 9% GF | 6.82% GF | 64.4 | 4 h at 80° C. |
| R2-K | 5% GF | 3.79% GF | 64 | 4 h at 80° C. |

Table 2 shows the weight percentages of the nano- or micro-sized charge with respect to the weight of the resin before cross-linking and excl. hardener, i.e. with respect to the weight of the oligomer. Table 2 also shows the weight percentage of the nano- or micro-sized charge with respect to the total weight of the film after cross-linking or curing.

### EXAMPLE 6

Specimens R2-A: 0.09 g montmorillonite (MMT, Laviosa) have been added to 6 g epoxy resin EP-506 (1.5% by weight with respect to the epoxy resin). Then, 1.92 g hardener (3.3-dimethyl-4.4-diamine-dicyclohexylmethane) have been added to the previously charged epoxy resin. The specimen has been kept for 4 hours at 80° C. for cross-linking. After cross-linking, the Rockwell hardness of the specimen was 64.4 HRC.

### EXAMPLE 7

Specimens R2-D: 0.18 g montmorillonite (MMT, Laviosa) have been added to 6 g epoxy resin EP-506 (3% by weight with respect to the epoxy resin). Then, 1.92 g hardener (3.3-dimethyl-4.4-diamine-dicyclohexylmethane) have been added to the previously charged epoxy resin. The specimen has been kept for 4 hours at 80° C. After cross-linking, the Rockwell hardness of the specimen was 64.4 HRC.

### EXAMPLE 8

This example refers to the preparation of a steel foil with a layer of resin R2-J. The foil with a 2 mm thick coating made of resin R2-J has been subjected to heat treatment (4 h at 80° C.). The Rockwell hardness of the final film was 64.4 HRC, and the film had good thermal conductivity.

In order to have better features in terms of thermal conductivity, together with great hardness, further specimens of epoxy resins have been prepared, charged with a greater amount of nano- and micro-sized charges according to what summarized in Table 3 and described in detail below.

TABLE 3

| | | | weight % type | weight % and | | |
|---|---|---|---|---|---|---|
| | | Hardness | of charge with | type of charge | | |
| | | Shore D/ | respect to the | on the total | Thermal | |
| | | Rockwell | starting epoxy | (resin after | conductivity | |
| specimen | resin | HRC | oligomer | cross-linking) | W/m° K | Curing |
| R2 | EP-506 | | — | — | 0.15-0.20 | 2 h at 80° C., |
| | | | | | | 2 h at 120° C., |
| | | | | | | 2 h at 160° C. |
| F.P. | DGEBA | 88/62 | Aluminum | 37.88% | 10.5 | 4 h at 60° C., |
| | | | oxide 50% | aluminum oxide | | 4 h at 80° C., |
| | | | BN 30% | 22.73% BN | | 2 h at 120° C. |
| D3 | DGEBA | 88/62 | Aluminum | 37.88% | 10.0 | 4 h at 60° C., |
| | | | oxide 50% | aluminum oxide | | 4 h at 80° C., |
| | | | MWCNT 5% | 3.79% MWCNT | | 2 h at 120° C. |
| D9 bis | EP-506 | 87/61.5 | BN 40% | 30.30% BN | 11.5 | 2 h at 80° C., |
| | | | | | | 2 h at 120° C., |
| | | | | | | 2 h at 160° C. |
| D11 | EP-506 | 88/62 | BN 20% | 15.15% BN | 10.7 | 2 h at 80° C., |
| | | | MWCNT, 3% | 2.27% MWCNT | | 2 h at 120° C., |
| | | | | | | 2 h at 160° C. |
| D10 | EP-506 | 88/62 | BN 20% | 15.15% BN | 11.2 | 2 h at 80° C., |
| | | | Graphene 3% | 2.27% MWCNT | | 2 h at 120° C., |
| | | | | | | 2 h at 160° C. |

Table 3, similarly to the previous Table 2, shows the weight percentages of the nano- or micro-sized charge with respect to the weight of the resin before cross-linking and excl. the hardener, i.e. with respect to the weight of the oligomer. Table 3 also shows the weight percentage of the nano- or micro-sized charge with respect to the total weight of the film after cross-linking or curing.

### EXAMPLE 9

Specimen R2: 1.92 g hardener H5 (Chemix) have been added to 6 g epoxy resin EP-506. The specimen has been then subjected to a cross-linking or curing cycle as follows: 2 hours at 80° C., 2 hours at 120° C., 2 hours at 160° C. The specimen has no micro- and nano-sized charges, and serves as comparison parameter for the subsequent examples, in particular as regards hardness and thermal conductivity.

### EXAMPLE 10

Specimen F.P.: 6 g of resin DGEBA have been charged with about 50% micro-sized aluminum oxide and 1.2/1.8 g (20-30%) micro-sized boron nitride (BN; CAS no.: 10043-11-5) marketed by Sigma-Aldrich s.r.l., Italy, average dimension about 1 micrometer.

The product has been mixed until the specimen was completely homogeneous. Then 0.60 g hardener 3.3-dimethyl-4.4-diamine-dicyclohexylmethane have been added. The mixture has been deposited, in a thickness of 2-3 mm, on a round mold made of steel, diameter 4 cm, and cured, i.e. cross-linked (4 h at 60° C., 4 h at 80° C., 2 h at 120° C.). After curing, the hardness of the specimen was 88 SHORE D/62 Rockwell HRC, and the thermal conductivity was 10.5 W/m° K.

Equivalent results have been obtained using aluminum trihydroxide instead of aluminum oxide, substantially in the same amounts.

### EXAMPLE 11

Specimen D3: 0.15 g (3% by weight with respect to the epoxy resin) nano tubes (MWCNT, Bayer) and 3 g (50% by weight) of aluminum oxide have been added to 6 g epoxy resin DGEBA. Then, 0.60 g hardener 3.3-dimethyl-4.4-diamine-dicyclohexylmethane have been added to the previously charged epoxy resin. The specimen has been heated for 4 h at 80° C. After curing, the Rockwell hardness of the specimen was 62 HRC. In other tests, a greater weight percentage of nano tubes has been used, i.e. 5% by weight, still referred to the epoxy resin. The specimen has been cured for 4 h at 60° C.; for 4 h at 80° C. and for 2 h at 120° C.

Similar results have been obtained using aluminum trihydroxide instead of aluminum oxide.

### EXAMPLE 12

Specimen D-9bis: 1.92 g hardener 3.3-dimethyl-4.4-diamine-dicyclohexylmethane have been added to 6 g epoxy resin EP-506 charged with 2.4 g boron nitride (Sigma-Aldrich) (40% by weight with respect to the resin). The specimen has been then heated for 2 h at 80° C., for 2 h at 120° C., for 2 h at 160° C. After curing, the Rockwell hardness of the specimen is 61.5 HRC., and the thermal conductivity is 11.5 W/m° K.

### EXAMPLE 13

Specimen D11: 1.92 g hardener 3.3-dimethyl-4.4-diamine-dicyclohexylmethane (Chemix) have been added to 6 g epoxy resin EP-506 charged with 1.2 g boron nitride (Sigma-Aldrich) (20% by weight with respect to the resin) and 0.18 g nano tubes (MWCNT Bayer) (3% by weight with respect to the resin). The specimen has been then heated for 2 h at 80° C., for 2 h at 120° C., for 2 h at 160° C. After curing, the Rockwell hardness of the specimen was 62 HRC. The thermal conductivity was 10,7 W/m° K.

### EXAMPLE 14

Specimen D10: 1.92 g hardener 3.3-dimethyl-4.4-diamine-dicyclohexylmethane (Chemix) have been added to 6 g epoxy resin EP-506 charged with 1.2 g boron nitride (Sigma-Aldrich) (20% by weight with respect to the resin) and 0.18 g graphene (3% by weight with respect to the resin).The specimen has been then heated for 2 h at 80° C., for 2 h at 120° C., for 2 h at 160° C. After curing, the Rockwell hardness of the specimen is 62 HRC., and the thermal conductivity is 11.2 W/m° K.

For the applications described herein, in addition to the epoxy resins also polyurethane resins (formulae III+IV) and polyurea resins (formulae II+IV) may be used.

The process to obtain a polyurethane resin is based on the reaction between a polyhydroxylated compound (polyol formula (III)) and a di-polyisocyanate with formula (IV); the process to obtain a polyurea resin is based on the reaction between an ammine compound of formula (II) and a di-polyisocyanate of formula (IV) according to the reactions summarized below:

Polyurethane formation:

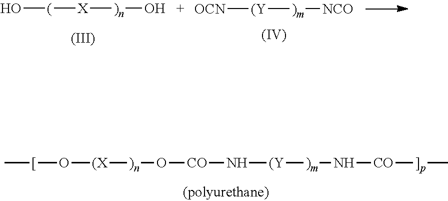

Polyurea formation:

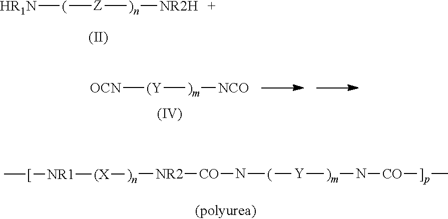

where:
R₁, R₂ can be independently: H, alkyl group, aromatic group, alkyl or aromatic ester group, siloxane group, ether aromatic group typically furan, under the condition that R₁ and R₂ are not both H.
Z=linear alkyl group or branched alkyl group, aromatic group both optionally substituted with other amine functional groups
X=linear alkyl group or branched alkyl group, aromatic group
Y=alkyl group, aromatic group
m=2-20
n=2-20
q=2-20
m and n may be independently equal to each other or different from each other
p=depends on the cross-linking degree set at 37-70% with respect to the reactive groups of isocyanate.

Pre-polymers may be also added to the formulation; they are a class of compounds constituted by polyols of formula II or aliphatic polyethers ending with alcohol functional groups suitable to react with di-isocyanate groups (III) before forming the resin.

The specimens produced and the measurements of the relevant parameters, in particular thermal conductivity and hardness as highlighted above, allow to conclude that a suitably charged thermoset resin may be used for producing a coating for the cylindrical outer surface of a Yankee cylinder or dryer, in order to provide protection of the metal surface, with high mechanical strength (hardness) to co-act with the detaching blade, and with high thermal conductivity allowing a correct heat exchange between the heat-transferring fluid flowing in the cylinder and the cellulose ply driven around said cylinder.

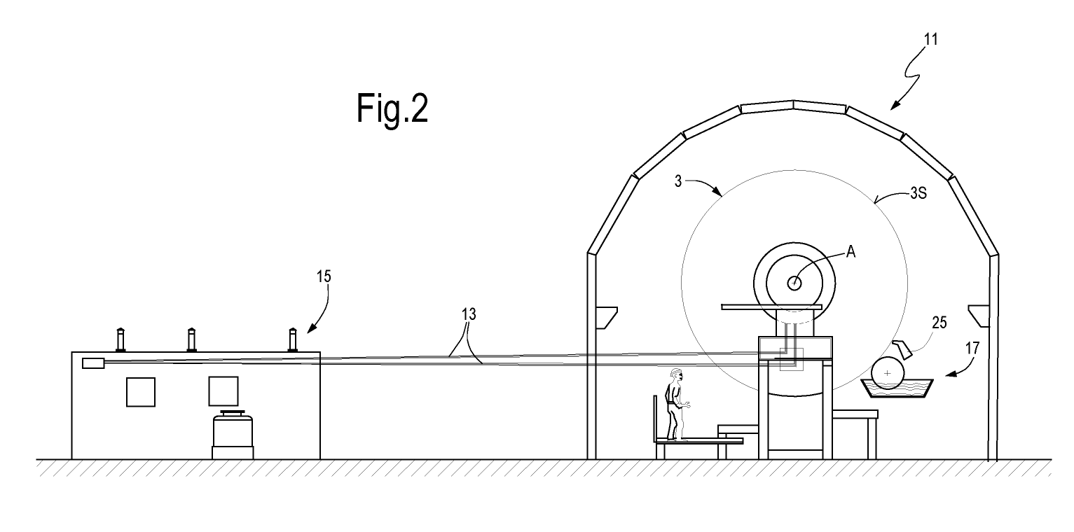

The charged resin may be applied to the cylindrical surface of the Yankee cylinder, and the resin may be cross-linked, according to a method described below with reference to FIGS. 2-6.

In FIG. 2 a shed 11 is shown, suitably equipped for the application of a coating to a new Yankee cylinder 3, or to a used Yankee cylinder, from which, if necessary, a worn or damaged coating has been removed, and to which a new coating shall be applied. The Yankee cylinder may be provided with a rotation system, for instance an electric motor controlling the rotation around the axis A.

The inner cavity of the Yankee cylinder may be connected to a steam generator unit 15 by means of ducts 13. The inner volume of the shed 11 may be connected to a ventilation system, not shown.

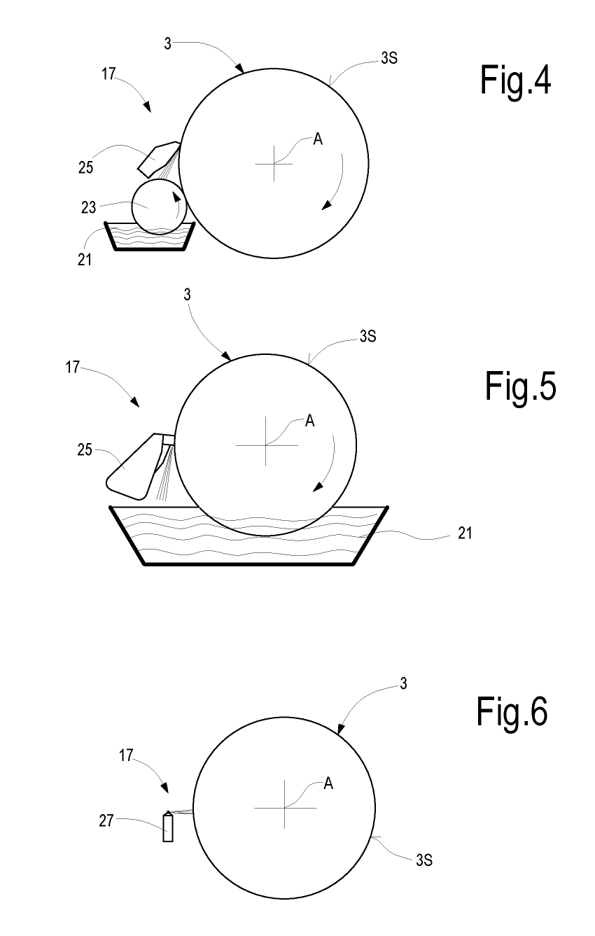

Inside the shed 11, means may be provided to apply the resin, to which hardener and micro- and/or nano-sized charges have been added, to the cylindrical outer surface 3S of the Yankee cylinder 3. The means for applying the resin are schematically shown at 17 in FIG. 2. Exemplary embodiments of said means will be described below with reference to FIGS. 4-6.

The charged resin, to which the hardener has been added, may be distributed on the outer surface 3S of the Yankee cylinder 3 while the cylinder is kept into rotation around the axis A. Together with, and/or after, the distribution of a resin layer of suitable thickness, for instance 2-5 mm, the Yankee cylinder 3 may be heated from the inside by flowing steam generated by the steam generator 15. The thermal energy supplied by the steam flowing in the Yankee cylinder 3 and dissipated through the cylindrical wall of the Yankee cylinder 3 is used for cross-linking or curing the resin. It is also possible to use a heat-transferring fluid other than steam to heat the Yankee cylinder, and/or a different method to supply the energy required for cross-linking the resin.

Typical temperatures of the surface of the Yankee cylinder may be approximately comprised between 80° C. and 160° C.

Therefore, the cross-linking cycle may be performed according to the times and methods illustrated with reference to the previous embodiments, by suitably controlling the conditions of the steam flowing in the Yankee cylinder 3. After the heat treatment, when the coating is completely hardened, the Yankee cylinder 3 may be subjected to final grinding. In this step, the initial thickness of the coating, that may be even of some millimeters, may be reduced so as to achieve the final thickness, that may be limited to some tenth of millimeter, for instance from 0.5 mm to 1.5 mm, preferably from 0.6 mm to 0.8 mm. This limited thickness allows to obtain a protection for the metal surface underneath, without limiting too much the heat exchange efficiency between the inside and the outside of the Yankee cylinder. This heat exchange efficiency is also promoted by the use of the micro- or nano-sized charges of thermally conductive material, as described with reference to the above mentioned examples, allowing to obtain heat exchange coefficients even greater than 10 W/m° K.

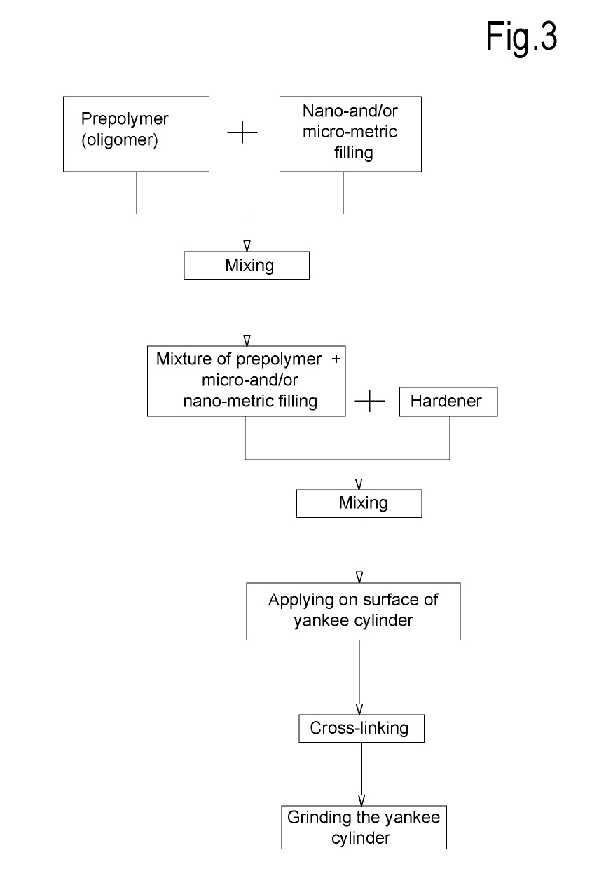

FIG. 3 shows a flow diagram summarizing the process described above. As shown in the diagram, in a first step of the method the pre-polymer (or oligomer) and the micrometric and/or nanometric charge(s) are mixed together. They are mixed preferably until homogenization of the charges in the resin. Then, the hardener is added to said mixture, and the compound obtained is mixed again until a substantially homogeneous compound is obtained. The mixture is applied to the outer surface of the Yankee cylinder and is then cross-linked. Then, the final grinding is carried out, if necessary.

The resin may be applied to the outer surface 3S of the Yankee cylinder 3 by means of one of the means known to those skilled in the art, selected based on the viscosity of the resin, for instance. FIGS. 4-6 schematically show three application modes. FIG. 4 shows a resin application system 17, configured as a spreading system comprising a tank 21, an application roller 23 and a spreading knife 25. The resin, with pre-polymer, hardener and micro- and/or nano-sized charges, is contained in the tank 21 and is supplied therefrom by means of the application roller 23, which rotates around the axis thereof according to the shown arrow, in a direction opposite to the rotation direction of the Yankee cylinder. In this way, in the contact area between the application roller 23 and the Yankee cylinder 3 there is a contact without slipping, and the resin is transferred from the application roller 23 to the Yankee cylinder 3. The spreading knife 25 spreads the resin, obtaining a layer of calibrated and approximately constant thickness.

In order to apply more viscous resins it is possible to use, preferably, an application system with a spreading knife and immersion of the Yankee cylinder 3 directly in the tank containing the resin. An embodiment of this type is shown in FIG. 5, where the same numbers indicate equal or equivalent parts as described with reference to FIG. 4. Transfer of the resin to the surface 3S of the Yankee cylinder occurs directly from the tank 21, where the Yankee cylinder 3 is partially immersed. The spreading knife 25 spreads the resin uniformly to obtain a film of adequate and substantially uniform thickness.

In other embodiments, an application system 17 may be used, comprising a spray applicator 27, as schematically shown in FIG. 6.

In some embodiments of the method described herein, the cylindrical outer surface of the Yankee cylinder 3 may be ground before applying the layer or film of resin forming the coating. The initial grinding may be done before heating the Yankee cylinder, i.e. when the Yankee cylinder is at room temperature. The grinding may be done so that the cylindrical outer surface of the Yankee cylinder 3 has a slight crowning, i.e. the diameter in the central area of the Yankee cylinder 3 is slightly greater than the diameter at the ends of the Yankee cylinder 3.

The Yankee cylinder 3 is preferably made of steel. It may have a cylindrical wall having a thickness comprised between about 20 mm and about 25 mm, and may be provided, on the inner surface, with annular grooves known per se, to collect the condensate that forms due to the heat transferring from the steam to the wall of the Yankee cylinder, both during the coating application step and during the normal use of the Yankee cylinder.

Thanks to the use of the layer of thermoset resin, charged with micro- and/or nano-sized particles as described above, it is not necessary to apply metallization layers to the steel surface of the Yankee cylinder. These metallization layers have been used in the prior art Yankee cylinders in order to give sufficient resistance against wear caused by the contact with the detaching and scraping blades of the Yankee cylinder. The application of the metallization layers requires very complex, polluting and expensive processes.

Vice versa, the application of the thermoset resin with the nano- and/or micro-sized charges, increasing the hardness and the thermal conductivity thereof, allows to have a less expensive finished product with suitable features in terms of hardness, wear-resistance and thermal conductivity.

Moreover, in the prior art cylinders, when the metallization layer applied to the steel is damaged, it shall be removed and replaced by means of a metallization process that shall be done in the paper mill, shutting down the plant for 10-15 days in order to completely replace the coating and grind it, with high costs both due to the intervention and to the production loss.

Conversely, the repair of the resin layer may be done on site, without the need for removing the whole coating. Namely, to this end it is sufficient to have available suitable means for applying the resin to the Yankee cylinder, substantially reproducing the process described with reference to FIGS. 2 and 3 in the paper mill and making a partial polishing of the repair, thus shutting down the plant for maximum 24 hours.

To simplify the methods for applying the resin in the paper mill, in the coating repair processes it is advantageous to use a spray applicator.

Both in the process for the formation of a new coating film and in the process for repairing an already formed film on the Yankee cylinder, the two-component resin advantageously polymerizes with a step polyaddition mechanism without emitting volatile compounds, i.e. without emitting organic gaseous emissions.

In advantageous embodiments, the two-component resin may be applied in an aqueous suspension.

While the particular embodiments of the invention described above have been shown in the drawing and described integrally in the description above with features and characteristics relating to different example embodiments, those skilled in the art will understand the modifications, changes and omissions are possible without however departing from the innovative learning, the principles and the concepts described above and the advantages of the object described in the attached claims.

In particular, the nano- and micro-sized particles described above are examples of possible materials that can be used in combination with a thermoset two-component (pre-polymer+hardener) resin, in order to obtain a coating for the Yankee cylinder of suitable hardness and thermal conductivity. Based on the examples described above, those skilled in the art may use other materials, individually or in combination, in suitable percentages, in order to achieve a coating hardness and thermal conductivity suitable to use on Yankee cylinders. The hardness values considered to be suitable for these applications are hardness values greater than 58 Rockwell HRC or 81 Shore D. The thermal conductivity values suitable for these applications are thermal conductivity values equal to, or greater than, 8 W/m° K, preferably equal to, or greater than, 10 W/m° K.

Therefore, the scope of the described improvements shall be determined only based upon the widest interpretation of the attached claims, so as to include all the modifications, changes and omissions. Furthermore, the order or sequence of any step of method or process may be changed according to alternative embodiments.

In the description above and the appended claims, Yankee cylinder also refers to a dryer, or drying cylinder, for processing paper plies.

1. A method for coating a Yankee cylinder of a system for drying a cellulose ply, the method comprising the steps of:
applying, to an outer cylindrical surface of the Yankee cylinder, a coating based upon a reactive two-component resin, comprising a curable resin, a hardener, and a charge of at least one of nano-sized particles and micro-sized particles;
cross-linking the reactive two-component resin and forming a coating film on the outer cylindrical surface of the Yankee cylinder, formed by a matrix of cross-linked polymer resin containing a dispersion of the at least one of the nano-sized particles and the micro-sized particles.

2. A method according claim 1, wherein the coating film has a thickness of at least about 1 mm and the method further comprising:
grinding the coating film to a thickness of about 0.8 mm or less after the coating film is formed.

3. (canceled)

4. A method according to claim 1, wherein the at least one of the nano-sized particles and the micro-sized particles comprises at least one of: nanosilicates; metal oxides; carbon nano tubes; graphene; graphene oxide; graphite; aluminum oxide; aluminum trihydroxide; silica; montmorillonite; sodium montmorillonite; organic modified montmorillonite; metal powders used individually or mixed together; and combinations thereof.

5. A method according to claim 1, wherein charges of the at least one of the nano-sized particles and the micro-sized particles are comprised between about 1% and about 90% by weight with respect to a weight of the curable resin.

6. A method according to claim 1, wherein after resin cross-linking the coating film has a Rockwell hardness equal to, or greater than, about 58 HRC.

7. A method according to claim 1, wherein, after cross-linking, a thermal conductivity of the coating film is at least about 1 W/m° K.

8. A method according to claim 1, wherein a glass transition temperature of the coating film after cross-linking is comprised between about 140° C. and about 180° C.

9. A method according to claim 1, wherein the reactive two-component resin contains a resin comprising one of epoxy resins, polyurethane, resins and polyurea resins.

10. A method according to claim 1, wherein the coating film is obtained from a two-component resin comprising a hardener and an epoxy resin with formula 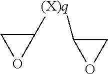
where:
X is a linear alkyl group or a branched alkyl group, or a cycloaliphatic group, or an aromatic group;
q=2-20.

11. A method according to claim 10, wherein the hardener has formula
HR₁N—(Z)ₙ—NR₂H
where:
R₁, R₂ can be independently: H, an alkyl group, an aromatic group, an alkyl or aromatic ester group, a siloxane group, an ether aromatic group typically furan, under a condition that R₁ and R₂ are not simultaneously both H;
Z is an alkyl group, an aromatic group; optionally substituted with other amine functional groups;
n=2-20.

12. A method according to claim 10, wherein the epoxy resin has formula 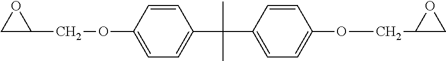 [SMILES: CC(C)(c1ccc(OCC2CO2)cc1)c1ccc(OCC2CO2)cc1]
and wherein the hardener is preferably diethylenetriamine with formula
H₂N—CH₂—CH₂—NH—CH₂—CH₂—NH₂.

13. A method according to claim 1, wherein the coating film is obtained from a polyurethane resin constituted by a polyisocyanate (NCO per molecule greater than 2) and a polyol/polyamine (OH/NH groups per molecule equal to, or greater than, 2) and wherein the OH(NH)/NCO stoichiometric ratio is equal to, or greater than, 1.

14. A method according to claim 13, wherein the polyisocyanate has an aromatic or cycloaliphatic structure.

15. A method according to claim 1, wherein applying the coating based on the reactive two-component resin on the outer cylindrical surface of the Yankee cylinder comprises the steps of:
keeping the Yankee cylinder rotating about an axis thereof;
applying the reactive two-component resin on the outer cylindrical surface of the Yankee cylinder while the Yankee cylinder rotates about the axis thereof.

16. A method according to claim 1, wherein cross-linking the reactive two-component resin comprises the steps of:
heating the Yankee cylinder inside, by means of a heat-transfer fluid;
transferring thermal energy from an inside of the Yankee cylinder to the outer cylindrical surface of the Yankee cylinder;
cross-linking the reactive two-component resin by means of the thermal energy transferred to the outer cylindrical surface of the Yankee cylinder.

17. A Yankee cylinder comprising:
a cylindrical outer surface, configured and arranged such as to be in contact with a cellulose ply, wherein the cylindrical outer surface is coated with a coating film made of polymeric thermoset resin, containing a charge of at least one of micro-sized particles nano-sized particles.

18. A Yankee cylinder according to claim 17, wherein the at least one of the nano-sized particles and the micro-sized particles comprises at least one of: metal oxides; carbon nano tubes; graphene; graphene oxide; graphite; aluminum oxide; aluminum trihydroxide; silica; montmorillonite; organic modified montmorillonite; sodium montmorillonite; metal powders used individually or mixed together; and combinations thereof.

19. A Yankee cylinder according to claim 17, wherein percentages of the at least one of the nano-sized particles and the micro-sized charges are comprised between about 10% and about 80% by weight with respect to a total weight of the coating film.

20. A Yankee cylinder according to claim 17, wherein the coating film has a Rockwell hardness equal to, or greater than, about 58 HRC.

21. A Yankee cylinder according to claim 17, wherein a thickness of the coating film is equal to, or lower than, about 2 mm.

22. A Yankee cylinder according to claim 17, wherein a thermal conductivity of the coating film is equal to, or greater than, about 1 W/m° K.

23. A Yankee cylinder according to claim 17, wherein the coating film is constituted by a resin, crosslinked by means of a hardener, the resin comprising one of epoxy, resins, polyurethane resins and polyurea resins.

24. A method according to claim 1, wherein charges of the at least one of the nano-sized particles and the micro-sized particles are comprised between about 5% and about 85% by weight with respect to a weight of the curable resin.

25. A method according to claim 1, wherein charges of the at least one of the nano-sized particles and the micro-sized particles are comprised between about 20% and about 80% by weight with respect to a weight of the curable resin.

26. A method according to claim 1, wherein charges of the at least one of the nano-sized particles and the micro-sized particles are comprised between about 40% and about 80% by weight with respect to a weight of the curable resin.

27. A method according to claim 1, wherein, after cross-linking, a thermal conductivity of the coating film is at least about 5 W/m° K.

28. A method according to claim 1, wherein, after cross-linking, a thermal conductivity of the coating film is at least about 8 W/m° K.

29. A Yankee cylinder according to claim 17, wherein a percentage of the at least one of the nano-sized particles and the micro-sized charges is comprised between about 15% and about 70% by weight with respect to a total weight of the coating film.

30. A Yankee cylinder according to claim 17, wherein a thickness of the coating film is equal to, or lower than, about 1.5 mm.

31. A Yankee cylinder according to claim 17, wherein a thickness of the coating film is comprised between about 0.4 mm and about 0.8 mm.

32. A Yankee cylinder according to claim 17, wherein a thermal conductivity of the coating film is equal to, or greater than, about 5 W/m° K.

33. A Yankee cylinder according to claim 17, wherein a thermal conductivity of the coating film is equal to, or greater than, about 8 W/m° K.
